(19) United States
(12) Patent Application Publication
(10) Pub. No.: US 2024/0185078 A1
(43) Pub. Date: Jun. 6, 2024

(54) PURIFIED CONTRASTIVE LEARNING FOR LIGHTWEIGHT NEURAL NETWORK TRAINING

(71) Applicant: QUALCOMM Incorporated, San Diego, CA (US)

(72) Inventors: Simyung CHANG, Suwon (KR); Byeonggeun KIM, Seoul (KR); Seunghan YANG, Seoul (KR); Kyuhong SHIM, Seoul (KR)

(21) Appl. No.: 18/456,112

(22) Filed: Aug. 25, 2023

Related U.S. Application Data
(60) Provisional application No. 63/419,272, filed on Oct. 25, 2022.

(51) Int. Cl. G06N 3/088; G06N 3/04

(52) U.S. Cl. CPC G06N 3/088; G06N 3/04

(57) ABSTRACT

A processor-implement method includes generating, for each input of a group of inputs, a clean sample and an augmented sample. The method also includes associating, for each input of the group of inputs, the clean sample with the augmented sample to form a positive pair. The method further includes associating, for each input of the group of inputs, the clean sample with another clean sample associated with another input of the group of inputs to form a negative pair. The method still further includes learning one or more representations of the group of inputs based on the positive pair and the negative pair of each input of the group of inputs.

### CROSS-REFERENCE TO RELATED APPLICATION

The present application claims the benefit of U.S. Provisional Patent Application No. 63/419,272, filed on Oct. 25, 2022, and titled “PURIFIED CONTRASTIVE LEARNING FOR LIGHTWEIGHT NEURAL NETWORK TRAINING,” the disclosure of which is expressly incorporated by reference in its entirety.

### FIELD OF THE DISCLOSURE

Aspects of the present disclosure generally relate to training artificial neural networks via purified contrastive learning.

### BACKGROUND

Artificial neural networks may comprise interconnected groups of artificial neurons (e.g., neuron models). The artificial neural network may be a computational device or be represented as a method to be performed by a computational device. Some artificial neural networks may be trained in a supervised manner from labeled data, allowing for the development of specialized models that excel in their designated tasks. Still, as a practical matter, labeling every possible element in the world is an impractical feat. Additionally, certain tasks, such as training speech recognition systems on ancient dialects, suffer from a scarcity of labeled data. Consequently, the reliance on supervised learning can impede the development of more intelligent generalist models that can perform multiple tasks and/or acquire new skills. Therefore, some artificial neural networks are trained in a self-supervised manner on unlabeled data.

Contrastive learning is an example of a framework for self-supervised learning in various tasks. The goal of contrastive learning is to train an artificial neural network to learn representations of data without relying on explicit labels. The representations may be learned by contrasting positive and negative pairs of examples. During training, the artificial neural network learns to map similar augmented samples closer together in the feature space, while pushing dissimilar samples farther apart. This process encourages the artificial neural network to capture meaningful and discriminative representations of the data.

### SUMMARY

In some aspects of the present disclosure, a method includes generating, for each input of a group of inputs, a clean sample and an augmented sample. The method further includes associating, for each input of the group of inputs, the clean sample with the augmented sample to form a positive pair. The method also includes associating, for each input of the group of inputs, the clean sample with another clean sample associated with another input of the number of inputs to form a negative pair. The method further includes learning one or more representations of the group of inputs based on the positive pair and the negative pair of each input of the group of inputs.

Some aspects of the present disclosure are directed to an apparatus including means for generating, for each input of a group of inputs, a clean sample and an augmented sample. The apparatus further includes means for associating, for each input of the group of inputs, the clean sample with the augmented sample to form a positive pair. The apparatus further includes means for associating, for each input of the group of inputs, the clean sample with another clean sample associated with another input of the number of inputs to form a negative pair. The apparatus further includes means for learning one or more representations of the group of inputs based on the positive pair and the negative pair of each input of the group of inputs.

In some aspects of the present disclosure, a non-transitory computer-readable medium with program code recorded thereon is disclosed. The program code is executed by a processor and includes program code to generate, for each input of a group of inputs, a clean sample and an augmented sample. The program code further includes program code to associate, for each input of the group of inputs, the clean sample with the augmented sample to form a positive pair. The program code also includes program code to associate, for each input of the group of inputs, the clean sample with another clean sample associated with another input of the number of inputs to form a negative pair. The program code further includes program code to learn one or more representations of the group of inputs based on the positive pair and the negative pair of each input of the group of inputs.

Some aspects of the present disclosure are directed to an apparatus having one or more processors, and one or more memories coupled with the one or more processors and storing instructions operable, when executed by the one or more processors, to cause the apparatus to generate, for each input of a group of inputs, a clean sample and an augmented sample. Execution of the instructions also cause the apparatus to associate, for each input of the group of inputs, the clean sample with the augmented sample to form a positive pair. Execution of the instructions also cause the apparatus to associate, for each input of the group of inputs, the clean sample with another clean sample associated with another input of the number of inputs to form a negative pair. Execution of the instructions further cause the apparatus to learn one or more representations of the group of inputs based on the positive pair and the negative pair of each input of the group of inputs.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 3 is a block diagram illustrating an example of a conventional contrastive learning framework.

FIG. 4 is a block diagram illustrating an example of a contrastive learning framework, in accordance with certain aspects of the present disclosure.

FIG. 5 is a flow diagram illustrating an example of a process for contrastive learning, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures, and in the following description of the preferred aspects. The detailed description and drawings are merely illustrative of the disclosure rather than limiting, the scope of the disclosure being defined by the appended claims and equivalents thereof.

As discussed, some artificial neural networks may be trained in a supervised manner from labeled data, allowing for the development of specialized models that excel in their designated tasks. Still, the reliance on supervised learning can impede the development of more intelligent generalist models that can perform multiple tasks and/or acquire new skills. Therefore, an artificial neural network's capability to perform a task may be improved if the artificial neural network can be trained in a self-supervised manner on unlabeled data.

Self-supervised learning is a training approach that allows an artificial neural network to learn from unlabeled data by deriving supervisory signals from the data itself. Contrastive learning is an example of a framework for self-supervised learning in various tasks. The goal of contrastive learning is to train an artificial neural network to learn representations of data without relying on explicit labels. During training, the artificial neural network learns to map positive pairs (e.g., matching pairs) together while pushing negative pairs (e.g., non-matching pairs) apart, resulting in a discriminative embedding space. For example, in image recognition, contrastive learning may be used to train an image recognition model to identify the original image among the augmented versions by maximizing the similarity between positive pairs (original image and its augmentations) while minimizing the similarity with negative pairs (images from different classes or unrelated images). This process allows the image recognition model to learn meaningful representations without relying on explicit labels. Some contrastive learning methods have been successful in achieving performance levels similar to supervised training on large models. Still, for lightweight models, contrastive learning methods may not achieve the same, or similar, performance as supervised training.

Various aspects of the present disclosure are directed to a purified contrastive learning framework that may be used to train lightweight models. In some examples, positive and negative pairs may be re-defined to remove unnecessary information while retaining discriminative information from unlabeled data.

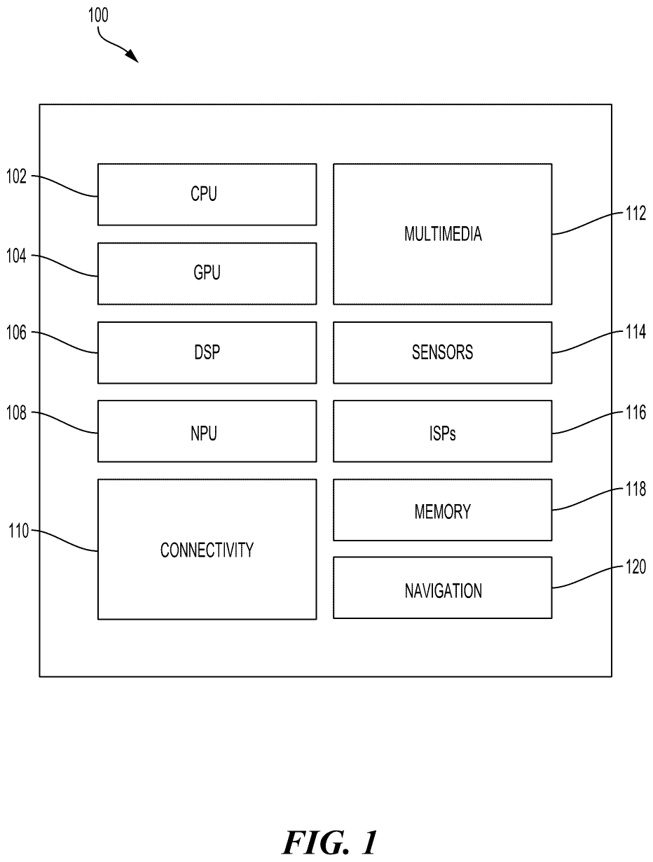

FIG. 1 illustrates an example implementation of a system-on-a-chip (SOC) 100, which may include a central processing unit (CPU) 102 or a multi-core CPU configured for training artificial neural networks via purified contrastive learning. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to generate, for each input of a number of inputs, a clean sample and an augmented sample; associate, for each input of the number of inputs, the clean sample with the augmented sample to form a positive pair; associate, for each input of the number of inputs, the clean sample with another clean sample of another input of the number of inputs to form a negative pair; and learn one or more representations of the number of inputs based on the positive pair and the negative pair of each input of the number of inputs.

Object recognition is an example of a task performed by an artificial neural network. In some examples, an object recognition task learns to represent inputs at successively higher levels of abstraction in each layer, thereby building up a useful feature representation of the input data.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

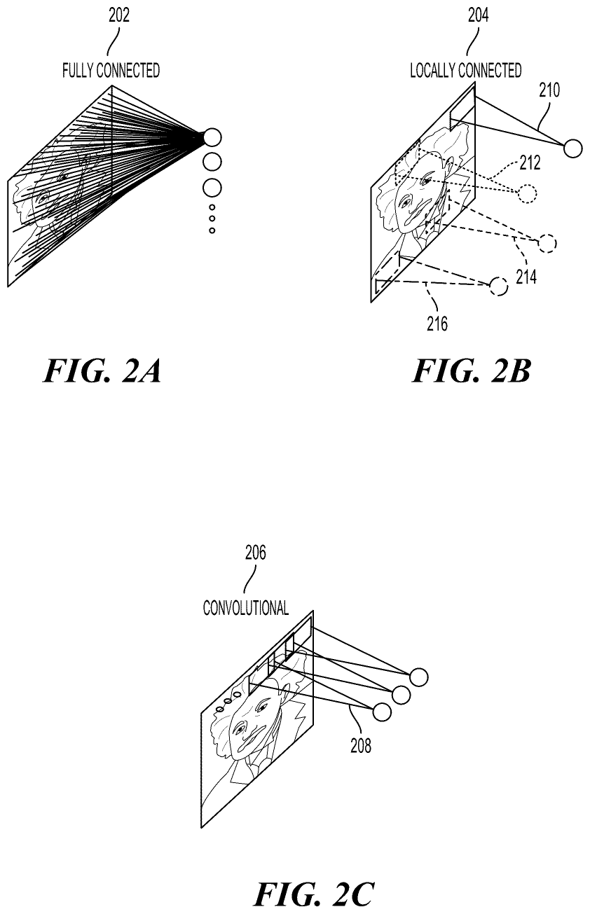

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

As discussed, some artificial neural networks may be trained in a supervised manner from labeled data, allowing for the development of specialized models that excel in their designated tasks. Still, the reliance on supervised learning can impede the development of more intelligent generalist models that can perform multiple tasks and/or acquire new skills. Therefore, an artificial neural network's capability to perform a task may be improved if the artificial neural network can be trained in a self-supervised manner on unlabeled data.

Self-supervised learning is a training approach that allows an artificial neural network to learn from unlabeled data by deriving supervisory signals from the data itself. Contrastive learning is an example of a framework for self-supervised learning in various tasks. Contrastive learning is a technique in machine learning (e.g., artificial neural networks) that aims to learn meaningful representations by contrasting positive and negative pairs of examples. The objective of contrastive learning is to bring similar examples closer together in a learned representation space while pushing dissimilar examples apart, resulting in a discriminative embedding space.

In conventional contrastive learning, a respective set of augmented samples is generated from each input sample of a group of input samples. These augmented samples share a same identity as the original input sample but are modified in some way. Positive pairs are formed by matching augmented samples from the same input sample, while negative pairs consist of augmented samples from different input samples.

In most cases, a contrastive loss function quantifies the similarity between pairs of examples in the representation space, such that a similarity between positive pairs is maximized or increased, while a similarity between negative pairs is minimized or decreased. During training, the model may be optimized to learn representations that effectively discriminate between positive and negative pairs. By doing so, the model learns to capture meaningful and informative features that are useful for downstream tasks, such as (but not limited to) classification, retrieval, or clustering.

Contrastive learning has gained significant attention and success, particularly in the field of computer vision, where contrastive learning has been successfully applied to image recognition, object detection, image retrieval tasks, and/or the like. By leveraging the structure and relationships within the data, contrastive learning enables the model to capture relevant patterns and representations without the need for explicit labels, making contrastive learning a valuable tool for self-supervised learning and unsupervised representation learning.

For example, in image recognition, contrastive learning may be used to train an image recognition model to identify the original image among the augmented versions by maximizing the similarity between positive pairs (original image and its augmentations) while minimizing the similarity with negative pairs (images from different classes or unrelated images). This process allows the image recognition model to learn meaningful representations without relying on explicit labels. Some contrastive learning methods have been successful in achieving performance levels similar to supervised training on large models. Still, for lightweight models, contrastive learning methods do not achieve the same, or similar, performance as supervised training.

For example, self-supervised learning has demonstrated notable advancements in the audio and speech domains. Some speech-related tasks often implement lightweight models that may operate on low-power devices, such as an edge device. For instance, applications, such as keyword spotting for voice assistants, may use lightweight models with always-on behavior. These keyword spotting applications for voice assistants may operate on low-power edge devices.

An edge device is an example of a computing device that is located close to a source of data generation. The edge device may perform processing tasks and make real-time decisions at or near the location where the data is being generated, rather than relying on transmitting the data to a centralized server or the cloud for processing. Edge devices are typically small, lightweight, and energy-efficient devices that can be deployed in various environments, including (but not limited to) Internet of Things (IoT) devices, smartphones, smart sensors, wearables, routers, embedded systems, hub systems, etc. In some cases, the processing resources and/or memory resources of an edge device may be less than the processing resources and/or memory resources of non-edge devices.

Edge devices may be useful in scenarios where network bandwidth is limited, or there are concerns about data privacy, network latency, or intermittent connectivity. Examples of edge computing applications include smart homes, industrial automation, autonomous vehicles, remote monitoring, healthcare monitoring devices, and smart cities. Edge devices may leverage machine learning models to enable local decision-making and intelligence at the edge. This allows for real-time processing, predictive analytics, anomaly detection, and localized intelligence without relying heavily on cloud-based services.

Conventional contrastive learning frameworks have been generally ineffective when used to train a lightweight model (e.g., small model). These conventional contrastive learning frameworks heavily rely on complex pretexts for training lightweight models. The training results in a lightweight model with reduced accuracy.

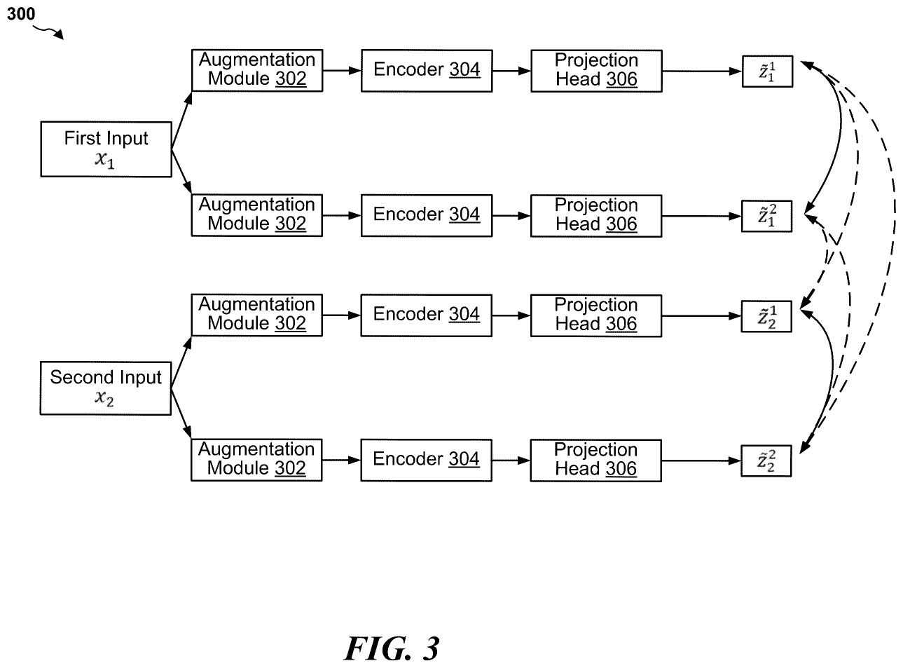

FIG. 3 is a block diagram illustrating an example of a conventional contrastive learning framework 300. As shown in the example of FIG. 3, in the conventional contrastive learning framework 300, an augmentation module 302 may generate a pair of augmented samples from each input x₁ and x₂. The augmentation may be an example of a pretext task. The augmentation module 302 may be a stochastic augmentation module that randomly transforms a given input to generate two correlated views of the same input. Specifically, in the example of FIG. 3, for the pretext task, N examples {xᵢ}ᵢ₌₁^{N} in a minibatch are transformed via the augmentation module 302 to form pairs of augmented samples, resulting in 2N data points {\tilde{x}ᵢ}ᵢ₌₁^{2N}. Each pair of augmented examples may be considered a positive pair. The augmentations may include, for example, cropping, resizing, distorting, and/or applying a random Gaussian blur to each input x₁ and x₂. For a minibatch of N examples, i∈I={1 . . . 2N} represents an index of two different pairs of augments samples. The variable j represents an index of the other augmented sample from a same sample source xᵢ.

The sample output of the augmentation module 302 may be encoded via an encoder 304 associated with an encoding function ƒ(⋅) that extracts representation vectors from augmented data examples. Each representation vector may be processed by a projection head 306 associated with a projection function g(⋅) that maps the respective representations to a space where contrastive loss is applied. That is, the projection head 306 may transform the encoded data into a different feature space or dimension, often with a reduced dimensionality, while preserving relevant information. As shown in the example of FIG. 3, a respective pair of augmented samples (\tilde{z}₁¹, \tilde{z}₁²) and (\tilde{z}₂¹, \tilde{z}₂²) may be generated for each input x₁ and x₂. Each augmented sample, within a pair of augmented samples, is a positive match (shown as a solid arrow) to a corresponding augmented sample within the pair. For example, a first augmented sample \tilde{z}₁¹ is a positive match to a second augmented sample \tilde{z}₁² within the pair of augmented samples (\tilde{z}₁¹, \tilde{z}₁²associated with a first input x₁. Furthermore, each augmented sample, within the pair of augmented samples, is a negative match (shown as a dashed arrow) to another augmented sample within another pair of augmented samples. For example, a first augmented sample \tilde{z}₁¹ is a negative match to both a third augmented sample \tilde{z}₂¹ and a fourth augmented sample \tilde{z}₂² associated with a second input x₂, and vice versa.

A loss function for the conventional contrastive learning framework 300 is as follows:

$${i , j}_{} = - log \frac{exp ( sim ( {\tilde{z}}_{i} , {\tilde{z}}_{j} ) / τ )}{{\sum }_{k = 1}^{2 N} {}_{[ k \neq 1 ]} exp ( sim ( {\tilde{z}}_{i} , {\tilde{z}}_{j} ) / τ )} \qquad ( 1 )$$

In Equation 1, [symbol] _{[k≠i]}∈{0,1} represents an indicator function, and \tilde{z}ᵢ=g(ƒ(\tilde{x}ᵢ)) is a latent representation of an augmented sample \tilde{x}ᵢ extracted from the encoder 304 (ƒ(⋅)) and projection head 306 (g(⋅)) . A similarity function (sim(u, v) sim(u, v)=u^{T}v/∥u∥∥v∥) represents a dot product between [symbol] ₂ normalized u and v (e.g., cosine similarity). An index i represents an anchor and an index j represents a positive associated with the anchor. The other 2(N−1) indices represent negative samples in relation to the anchor and the positive. For example, the first augmented sample \tilde{z}₁¹ may be an anchor and the second augmented sample \tilde{z}₁² may be a positive. The third augmented sample \tilde{z}₂¹ and the fourth augmented sample \tilde{z}₂² may be negative samples to the anchor and the positive. As shown in the example of FIG. 3, all positive and negative pairs are augmented samples. In Equation 1, τ represents a temperature parameter.

The pretexts used in the conventional contrastive learning framework 300, described with reference to FIG. 3, increase a complexity of the conventional contrastive learning framework 300. Therefore, the described pretexts (e.g., generating two augmented samples per input) are not suitable when training lightweight models. Various aspects of the present disclosure are directed to a contrastive learning framework that is suitable for a lightweight model.

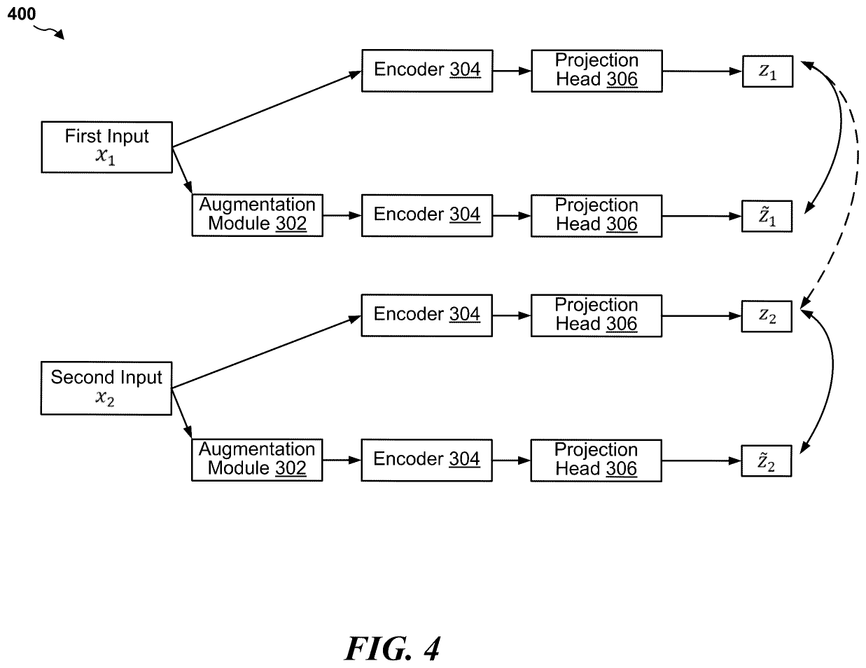

FIG. 4 is a block diagram illustrating an example of a contrastive learning framework 400, in accordance with various aspects of the present disclosure. In the example of FIG. 4, the contrastive learning framework 400 incorporates unidirectional attraction (UDA) to align a single embedding space by increasing a similarity between an augmented sample and a clean sample associated with an input. An embedding space refers to a mathematical representation or feature space where data points or entities are transformed into a lower-dimensional vector representation. In the context of machine learning, an embedding space may capture and represent the latent or underlying characteristics of the data.

As shown in the example of FIG. 4, for each input x₁ and x₂, the contrastive learning framework 400 generates a clean sample zᵢ and an augmented sample \tilde{z}ᵢ. The clean sample zᵢ refers to a sample that is generated by encoding the input via an encoder 304 associated with an encoding function ƒ(⋅). A representation vector generated by the encoder 304 may be processed by a projection head 306 associated with a projection function g(⋅). As shown in FIG. 4, for a first input the contrastive learning framework 400 may generate a first clean sample z₁. For a second input x₂, the contrastive learning framework 400 may generate a second clean sample z₂.

The augmented sample \tilde{z}ᵢ refers to the sample that is generated by augmenting the input via the augmentation module 302. The output of the augmentation module 302 is processed by the encoder 304 and the projection head 306. As shown in FIG. 4, for a first input x₁, the contrastive learning framework 400 may generate a first augmented sample \tilde{z}₁. For a second input x₂, the contrastive learning framework 400 may generate a second augmented sample \tilde{z}₂.

In some examples, embeddings associated with a clean sample zᵢ may be aligned, or substantially aligned, with embeddings associated with the augmented sample \tilde{z}ᵢ. The clean sample is considered the ground truth. In such examples, a similarity, denoted as sim(zᵢ, \tilde{z}ᵢ), between the embeddings of the clean and augmented samples may be increased or maximized to align the embeddings. A complexity of the contrastive learning framework 400 may be reduced by considering the unidirectional attraction, such that the contrastive learning framework 400 may be used to train a lightweight model.

As shown in FIG. 3, the conventional contrastive learning framework 300 generates one or more negative pairs using augmented samples. A residual of an augmented sample \tilde{z}ᵢ and a clean sample zᵢ is ϵᵢ=\tilde{z}ᵢ−zᵢ. Therefore, a similarity between these two pairs is defined as follows S_{neg}=sim(zᵢ−ϵᵢ, zₖ−ϵₖ).

In some examples, discrimination between instances may be performed by reducing the similarity between these two pairs. The discriminative information relies on both the latent embedding z and the residual ϵ. If the positive pair increases robustness for data augmentation, this residual ϵ should not be used as discriminative information. Therefore, in the example of FIG. 4, the contrastive learning framework 400 uses a pure-negative repellent that only uses clean samples to generate a negative pair (shown as the dashed line in the example of FIG. 4). Additionally, an augmented sample \tilde{z}ᵢ is a positive match (shown as a solid line) with a corresponding clean sample zᵢ.

In the example of FIG. 4, a loss for the contrastive learning framework 400 is based on the unidirectional attraction and the pure-negative repellent. The loss may be determined as follows:

$${i , j}_{} = - log \frac{exp ( sim ( SG ( {z}_{i} ) , {\tilde{z}}_{i} ) / τ )}{{\sum }_{k = 1}^{N} exp ( sim ( {z}_{i} , {z}_{k} ) / τ )} \qquad ( 2 )$$

The goal of this loss function is to align the embeddings of the clean sample zᵢ and the augmented sample \tilde{z}ᵢ. In this equation, sim(SG(zᵢ), \tilde{z}ᵢ) represents the similarity between the stop-gradient operation applied to the clean sample zᵢ and the augmented sample \tilde{z}ᵢ. SG(⋅) represents a stop-gradient operation for an anchor of the positive pair. The stop-gradient operation prevents a gradient from propagating through the anchor of the positive pair. The loss function in Equation 2 consists of two components. The numerator term, exp(sim(SG(zᵢ), \tilde{z}ᵢ)/τ), represents the similarity between the stop-gradient operation of the clean sample zᵢ and the augmented sample \tilde{z}ᵢ, exponentiated and normalized with the temperature parameter τ. The numerator term encourages the alignment of the embeddings of the clean sample zᵢ and the augmented sample \tilde{z}ᵢ.

The denominator term, Σₖ₌₁^{N} exp(sim(zᵢ, zₖ)/τ), sums the similarities between the augmented sample zᵢ and all the negative samples zₖ in a minibatch, exponentiated and normalized with the temperature parameter τ. The denominator term represents the dissimilarity between the augmented sample and the negative samples. As discussed, the negative sample zₖ is a clean sample associated with another input.

By minimizing the loss function in Equation 2, the contrastive learning framework 400, described with reference to FIG. 4, maximizes the similarity between the stop-gradient operation and the augmented sample, while minimizing the similarities between the augmented sample and the negative samples. This encourages the alignment of the embeddings and helps in learning meaningful representations.

The contrastive learning framework 400, described with reference to FIG. 4, may be used for self-supervised learning for various lightweight models, such as lightweight neural speech models used on an edge device. In contrast to conventional contrastive learning frameworks that experience performance degradation in small models and small batch sizes, the contrastive learning framework 400 improves an accuracy of a lightweight model, even when only limited labeled data is available.

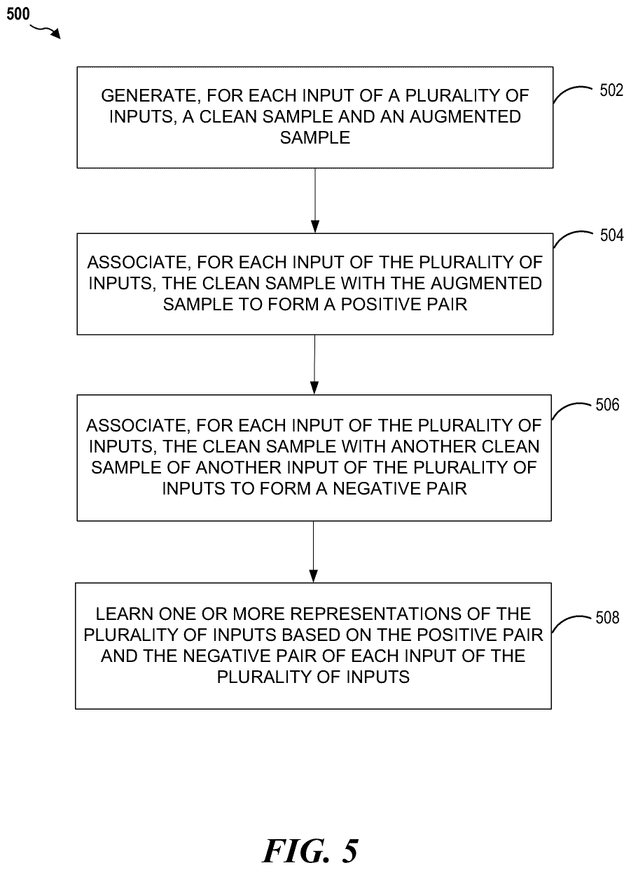

FIG. 5 is a flow diagram illustrating an example of a process 500 for contrastive learning (CL), in accordance with aspects of the present disclosure. As shown in FIG. 5, the process 500 begins at block 502 by generating, for each input of a group of inputs, a clean sample and an augmented sample. At block 504, the process 500 associates, for each input of the group of inputs, the clean sample with the augmented sample to form a positive pair. At block 506, the process 500 associates, for each input of the group of inputs, the clean sample with another clean sample associated with another input of the number of inputs to form a negative pair. At block 508, the process 500 learns one or more representations of the group of inputs based on the positive pair and the negative pair of each input of the group of inputs.

Implementation examples are described in the following numbered clauses:
Clause 1. A processor-implement method comprising: generating, for each input of a plurality of inputs, a clean sample and an augmented sample; associating, for each input of the plurality of inputs, the clean sample with the augmented sample to form a positive pair; associating, for each input of the plurality of inputs, the clean sample with another clean sample of another input of the plurality of inputs to form a negative pair; and learning one or more representations of the plurality of inputs based on the positive pair and the negative pair of each input of the plurality of inputs.
Clause 2. The processor-implemented method of any one of Clause 1, in which: learning the one or more representations comprises minimizing a loss for each input of the plurality of inputs; the clean sample is a ground truth; and a stop-gradient is a function of an embedding of the clean sample.
Clause 3. The processor-implemented method of any one of Clauses 1-2, further comprising learning the one or more representations via contrastive learning in a self-supervised manner.
Clause 4. The processor-implemented method of any one of Clauses 1-3, in which each input is an audio input.
Clause 5. The processor-implemented method of Clauses 1-4, further comprising receiving each input at a contrastive learning model.
Clause 6. The processor-implemented method of Clause 5, in which the contrastive learning model includes an augmentation module, an encoder, and a projection head.
Clause 7. The processor-implement method of Clause 6, in which the augmented sample is generated, via the augmentation module, in accordance with augmenting the clean sample with noise.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implement method comprising:
generating, for each input of a plurality of inputs, a clean sample and an augmented sample;
associating, for each input of the plurality of inputs, the clean sample with the augmented sample to form a positive pair;
associating, for each input of the plurality of inputs, the clean sample with another clean sample associated with another input of the plurality of inputs to form a negative pair; and
learning one or more representations of the plurality of inputs based on the positive pair and the negative pair of each input of the plurality of inputs.

2. The processor-implemented method of claim 1, wherein:
learning the one or more representations comprises minimizing a loss for each input of the plurality of inputs;
the clean sample is a ground truth; and
a stop-gradient is a function of an embedding of the clean sample.

3. The processor-implemented method of claim 1, further comprising learning the one or more representations via contrastive learning in a self-supervised manner.

4. The processor-implemented method of claim 1, wherein each input of the plurality of inputs is an audio input.

5. The processor-implemented method of claim 1, further comprising receiving each input at a contrastive learning model.

6. The processor-implemented method of claim 5, wherein the contrastive learning model includes an augmentation module, an encoder, and a projection head.

7. The processor-implement method of claim 6, wherein the augmented sample is generated, via the augmentation module, in accordance with augmenting the clean sample with noise.

8. An apparatus, comprising:
one or more processors; and
one or more memories coupled with the one or more processors and storing instructions operable, when executed by the one or more processors, to cause the apparatus to:
generate, for each input of a plurality of inputs, a clean sample and an augmented sample;
associate, for each input of the plurality of inputs, the clean sample with the augmented sample to form a positive pair;
associate, for each input of the plurality of inputs, the clean sample with another clean sample associated with another input of the plurality of inputs to form a negative pair; and
learn one or more representations of the plurality of inputs based on the positive pair and the negative pair of each input of the plurality of inputs.

9. The apparatus of claim 8, wherein:
execution of the instructions further cause the apparatus to minimize a loss for each input of the plurality of inputs in accordance with learning the one or more representations;
the clean sample is a ground truth; and
a stop-gradient is a function of an embedding of the clean sample.

10. The apparatus of claim 8, wherein execution of the instructions further cause the apparatus to learn the one or more representations via contrastive learning in a self-supervised manner.

11. The apparatus of claim 8, wherein each input of the plurality of inputs is an audio input.

12. The apparatus of claim 8, wherein execution of the instructions further cause the apparatus to receive each input at a contrastive learning model.

13. The apparatus of claim 12, wherein the contrastive learning model includes an augmentation module, an encoder, and a projection head.

14. The apparatus of claim 13, wherein the augmented sample is generated, via the augmentation module, in accordance with augmenting the clean sample with noise.

15. A non-transitory computer-readable medium having program code recorded thereon, the program code executed by one or more processors and comprising:
program code to generate, for each input of a plurality of inputs, a clean sample and an augmented sample;
program code to associate, for each input of the plurality of inputs, the clean sample with the augmented sample to form a positive pair;
program code to associate, for each input of the plurality of inputs, the clean sample with another clean sample associated with another input of the plurality of inputs to form a negative pair; and
program code to learn one or more representations of the plurality of inputs based on the positive pair and the negative pair of each input of the plurality of inputs.

16. The non-transitory computer-readable medium of claim 15, wherein:
the program code to learn the one or more representations comprises program code to minimize a loss for each input of the plurality of inputs;
the clean sample is a ground truth; and
a stop-gradient is a function of an embedding of the clean sample.

17. The non-transitory computer-readable medium of claim 15, wherein the program code further comprises program code to learn the one or more representations via contrastive learning in a self-supervised manner.

18. The non-transitory computer-readable medium of claim 15, wherein each input of the plurality of inputs is an audio input.

19. The non-transitory computer-readable medium of claim 15, wherein the program code further comprises program code to receive each input at a contrastive learning model.

20. The non-transitory computer-readable medium of claim 19, wherein the contrastive learning model includes an augmentation module, an encoder, and a projection head.

21. The non-transitory computer-readable medium of claim 20, wherein the augmented sample is generated, via the augmentation module, in accordance with augmenting the clean sample with noise.

22. An apparatus, comprising:
means for generating, for each input of a plurality of inputs, a clean sample and an augmented sample;
means for associating, for each input of the plurality of inputs, the clean sample with the augmented sample to form a positive pair;
means for associating, for each input of the plurality of inputs, the clean sample with another clean sample associated with another input of the plurality of inputs to form a negative pair; and
means for learning one or more representations of the plurality of inputs based on the positive pair and the negative pair of each input of the plurality of inputs.

23. The apparatus of claim 22, wherein:
the means for learning the one or more representations comprises means for minimizing a loss for each input of the plurality of inputs;
the clean sample is a ground truth; and
a stop-gradient is a function of an embedding of the clean sample.

24. The apparatus of claim 22, wherein execution of the instructions further cause the apparatus to learn the one or more representations via contrastive learning in a self-supervised manner.

25. The apparatus of claim 22, wherein each input of the plurality of inputs is an audio input.

26. The apparatus of claim 22, further comprising means for receiving each input at a contrastive learning model.

27. The apparatus of claim 26, wherein the contrastive learning model includes an augmentation module, an encoder, and a projection head.

28. The apparatus of claim 27, wherein the augmented sample is generated, via the augmentation module, in accordance with augmenting the clean sample with noise.
